(19) United States
(12) Patent Application Publication
(10) Pub. No.: US 2013/0174135 A1
(43) Pub. Date: Jul. 4, 2013

(54) CREATING A SHOCKWAVE FLASH FILE

(71) Applicants: Krishna G. Kiran, Bangalore (IN); Ravi Kishore Reddy, Bangalore (IN)

(72) Inventors: Krishna G. Kiran, Bangalore (IN); Ravi Kishore Reddy, Bangalore (IN)

(21) Appl. No.: 12/549,838

(22) Filed: Aug. 28, 2009

(51) Int. Cl. G06F 9/45

(52) U.S. Cl. 717/148

(57) ABSTRACT

A system identifies a first portion of a project as static code. The system compiles the static code to create compiled static code. The system identifies a second portion of the project as dynamic code that requires a plurality of compilations for a plurality of sub portions of the dynamic code to create compiled dynamic code. The system converts a subset of the dynamic code into dynamic byte code. The dynamic byte code reduces the plurality of dynamic code compilations necessary to create a SWF file. The system then merges the compiled static code and the dynamic byte code to create the SWF file.

### BACKGROUND

ShockWave Flash (SWF) is a file format for multimedia and vector graphics, and can contain animations or applets of varying degrees of interactivity and function. Once created, SWF files can be played by an application (e.g. Adobe Flash Player®, available from Adobe Systems Incorporated of San Jose, Calif.) working either as a browser plugin or as a standalone player. Action script is the scripting language for the SWF. When the SWF is playing, it executes the action script byte code present within it. The Action script code, which is a scripting code by Adobe Systems Incorporated used primarily for coding actions in Flash®. Early versions of various scripting languages used compile-time type checking and class-based syntax, such as the keywords class and extends. The earlier versions of scripting languages also typically utilized class-based inheritance syntax so that developers could create classes and interfaces, much as they would in class-based languages such as Java and C++.

Later versions of scripting languages (e.g., ActionScript 3.0) allowed developers to constrain variables to a specific type by adding a type annotation so that type mismatch errors could be found at compile-time. The later versions were a fundamental restructuring of the language, so much so that it an entirely different virtual machine is used for playback. For example, Flash Player 9 contains two virtual machines, AVM1 for code written in ActionScript 1 and 2, and AVM2 for content written in ActionScript 3.

When creating SWF files, movie clips exist as symbols (i.e., objects). A SWF file may contain multiple movie clips each represented as a slide object. Movie clips typically contain sound, text, graphics, etc., that are represented as slide element objects. In ActionScript 2, multiple symbols may be associated to an ActionScript 2 class. Writing the frame script code on the frame of the symbol initializes member variables of each instance of the ActonScript 2 class. In contrast to ActionScript2, in ActionScript 3 the frame script code has to be a member function inside the ActionScript 3 classes to which the symbol is associated. Therefore, each symbol (i.e., slide object, slide element object, etc.) must be associated with a unique class if some instance initialization should be done using frame script. During publishing (i.e., compilation) of the SWF file, each of those unique classes must be individually compiled.

### SUMMARY

Conventional computerized technologies for developing SWF files using a scripting language, such as ActionScript 3, suffer from a variety of deficiencies. In particular, conventional technologies for developing SWF files using a scripting language are limited in that conventional technologies require that each unique class must be individually compiled during publishing of the SWF file. Despite the fact that the classes are static and only the value of the member variable is different for each instance of a class, all the unique classes must be compiled each time an SWF developer publishes an SWF file. Therefore, as the SWF file grows in size (i.e., more slide objects are added to the SWF file, and each slide object contains multiple slide element objects, etc.), the publishing time also increases because each unique class must be compiled individually.

Embodiments disclosed herein significantly overcome such deficiencies and provide a SWF compiling and executing system for a scripting language that includes a computer system and/or software executing a SWF compiling and executing process that receives notification to compile a project to create an SWF file. The SWF compiling and executing process identifies a first portion of the project as static code. The static code requires compilation to create compiled static code. This compilation may be performed either during first publish or the compiled static code can be preserved with the SWF compilation process. The SWF compiling and executing process identifies a second portion of the project as dynamic code. The dynamic code requires a plurality of compilations for a plurality of sub portions of the project (i.e., all the unique classes must be individually compiled) to create compiled dynamic code. The SWF compiling and executing process converts a subset of the dynamic code into dynamic byte code. The compilation of the dynamic byte code reduces the plurality of compilations necessary during publishing to create the SWF file. In other words, a subset of the dynamic code is converted to dynamic byte code, thereby reducing the number of classes that must be compiled during publishing. Instead of a unique class for each slide object and each slide element object, there are a reduced number of static classes that can each reference multiple slide objects and slide element objects. The SWF compiling and executing process then merges the compiled static code and the dynamic byte code to create the SWF file. The SWF file compiles faster, and more efficiently.

During run time of the SWF file, for each component (such as a slide object) and each sub-component (such as a slide element object) rendered during the execution of the SWF file, the Adobe Flash Player executes a respective component class and sub-component class that each reference eXtensible Markup Language (XML) code used to initialize the member variables of the respective component class and sub-component class. The XML code is generated during the conversion of the subset of the dynamic code into dynamic byte code. In an example embodiment, when a user, such as a SWF developer, invokes the publishing process, the SWF compiling and executing process traverses the project to identify components and sub-components.

For example, the SWF compiling and executing process identifies a movie clip as a slide object (i.e., a component). For each slide object identified, the SWF compiling and executing process identifies slide item objects, such as MPEG-1 Audio Layer 3 (mp3) sound clips, text, captions, etc. (i.e., sub-components) that are rendered during the SWF file when the slide object (i.e., a component) is rendered. In other words, as the movie clip is executed in the SWF, there may be audio and captions rendered along with the movie clip.

In an example embodiment, as the SWF compiling and executing process identifies components within the SWF file, for each component identified, the SWF compiling and executing process associates the component to a component class and generates XML code associated with the component. Likewise, for each sub-component the SWF compiling and executing process identifies, the SWF compiling and executing process associates the sub-component to a sub-component class, and generates XML code associated with the sub-component. In an example embodiment, the Captivate project is parsed to identify the hierarchy and dependencies of the components and sub-components within the project. In an example embodiment, the component class and sub-component class may be compiled prior to the publishing of the SWF file thus reducing the overall compilation time of the SWF file.

In example embodiment, for each component and sub-component the SWF compiling and executing process identifies in the SWF project, the SWF compiling and executing process adds the respective component class and sub-component class to the SWF project. For example, the SWF compiling and executing process traverses a movie clip (i.e., a component) and determines a mp3 clip (i.e., a sub-component) exists within the movie clip. The SWF compiling and executing process does not know how many other mp3 clips exist within the project. The SWF compiling and executing process adds the mp3 sub-component class to the project. Thus, no matter how many more mp3 clips the SWF compiling and executing process identifies in the project, the SWF compiling and executing process needs only to compile the mp3 sub-component class once. During execution of the SWF file, accessing the compiled mp3 sub-component class (and referencing the respective initialization values via the XML code generated during the conversion process) renders the mp3 clips within the SWF file. The SWF file obtains the initialization values for a particular mp3 clip by referencing those initialization values through the compiled mp3 sub-component class.

In an example embodiment, the SWF compiling and executing process generates the XML code by creating a component node for each component identified. For each component property the SWF compiling and executing process identifies, the SWF compiling and executing process inserts the component property within the component node in the XML code. For each sub-component identified (that is associated with a respective component), the SWF compiling and executing process creates a sub-component node, and inserts the sub-component node in the XML code as a child node of the component node. For each sub-component property the SWF compiling and executing process identifies, the SWF compiling and executing process inserts the sub-component property within the sub-component node in the XML code.

In an example embodiment, when the XML code has been generated, the SWF compiling and executing process inserts the XML code into an initialization class associated with the dynamic byte code. The XML code is inserted into the initialization class as a member of that initialization class. During the publishing of the SWF file, this initialization class is compiled.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by Adobe Systems Incorporated of San Jose, Calif.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of a computer system according to one embodiment disclosed herein.

FIG. 2 is an example embodiment of current methods of compiling Action Script 3 code.

FIG. 3 is an example embodiment of the SWF compiling and executing process when it compiles a project.

FIG. 4 is an example embodiment of a flow chart of the SWF compiling and executing process when it traverses a project, and generates an XML file.

FIG. 5 is an example embodiment of the SWF compiling and executing process when it executes the SWF file.

FIG. 6 illustrates a flowchart of a procedure performed by the system of FIG. 1, when the SWF compiling and executing process receives notification to compile a project (i.e., compile the Adobe Captivate project) to create a SWF file, according to one embodiment disclosed herein.

FIG. 7 illustrates a flowchart of a procedure performed by the system of FIG. 1, when the SWF compiling and executing process, executes a respective component class and sub-component class, during execution of the SWF file, according to one embodiment disclosed herein.

FIG. 8 illustrates a flowchart of a procedure performed by the system of FIG. 1, when the SWF compiling and executing process converts a subset of the dynamic code into dynamic byte code reducing the plurality of compilations necessary to create the SWF file, according to one embodiment disclosed herein.

FIG. 9 illustrates a flowchart of a procedure performed by the system of FIG. 1, when the SWF compiling and executing process traverses the project to identify components to be rendered during execution of the SWF file, and for each component identified, associates the component to a component class according to one embodiment disclosed herein.

FIG. 10 illustrates a flowchart of a procedure performed by the system of FIG. 1, when the SWF compiling and executing process traverses the component to identify sub-components to be rendered during execution of the SWF file, according to one embodiment disclosed herein.

FIG. 11 illustrates a flowchart of a procedure performed by the system of FIG. 1, when the SWF compiling and executing process merges the compiled static code and the dynamic byte code to create the SWF file, according to one embodiment disclosed herein.

### DETAILED DESCRIPTION

Embodiments disclosed herein include a computer system executing a SWF compiling and executing process that receives notification to compile a project to create a SWF file. The SWF compiling and executing process identifies a first portion of the project as static code. The static code requires compilation to create compiled static code. The SWF compiling and executing process identifies a second portion of the project as dynamic code. The dynamic code requires a plurality of compilations for a plurality of sub portions of the project to create compiled dynamic code. The SWF compiling and executing process converts a subset of the dynamic code into dynamic byte code. The dynamic byte code reduces the plurality of compilations necessary to create the SWF file. In other words, a subset of the dynamic code is converted to dynamic byte code, thereby reducing the number of classes that must be compiled during publishing. The SWF compiling and executing process then merges the compiled static code and the dynamic byte code to create the SWF file.

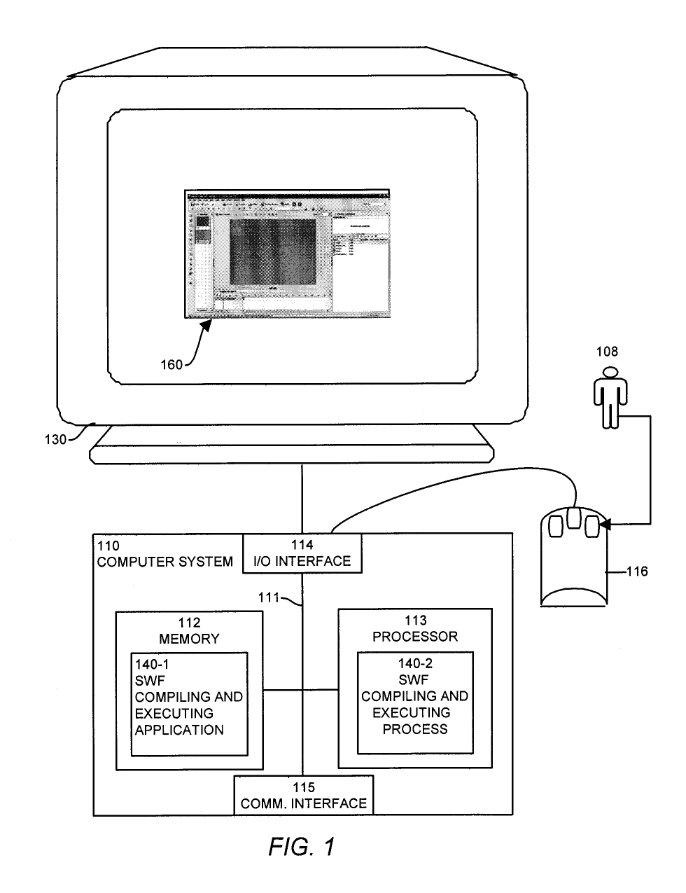

FIG. 1 is a block diagram illustrating example architecture of a computer system 110 that executes, runs, interprets, operates or otherwise performs a SWF compiling and executing application 140-1 and SWF compiling and executing process 140-2 suitable for use in explaining example configurations disclosed herein. The computer system 110 may be any type of computerized device such as a personal computer, workstation, portable computing device, console, laptop, network terminal or the like. An input device 116 (e.g., one or more user/developer controlled devices such as a keyboard, mouse, etc.) couples to processor 113 through I/O interface 114, and enables a user 108, such as a SWF developer, to provide input commands, and generally control the automatic graphical user interface 160 (used to create the Captivate project) that the SWF compiling and executing application 140-1 and process 140-2 provides on the display 130. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network (not shown).

The memory system 112 is any type of computer readable medium, and in this example, is encoded with a SWF compiling and executing application 140-1 as explained herein. The SWF compiling and executing application 140-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of a SWF compiling and executing application 140-1. Execution of a SWF compiling and executing application 140-1 in this manner produces processing functionality in SWF compiling and executing process 140-2. In other words, the SWF compiling and executing process 140-2 represents one or more portions or runtime instances of a SWF compiling and executing application 140-1 (or the entire a SWF compiling and executing application 140-1) performing or executing within or upon the processor 113 in the computerized device 110 at runtime.

It is noted that example configurations disclosed herein include the SWF compiling and executing application 140-1 itself (i.e., in the form of un-executed or non-performing logic instructions and/or data). The SWF compiling and executing application 140-1 may be stored on a computer readable medium (such as a floppy disk), hard disk, electronic, magnetic, optical, or other computer readable medium. A SWF compiling and executing application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a SWF compiling and executing application 140-1 in the processor 113 as the SWF compiling and executing process 140-2. Those skilled in the art will understand that the computer system 110 may include other processes and/or software and hardware components, such as an operating system not shown in this example.

A display 130 need not be coupled directly to computer system 110. For example, the SWF compiling and executing application 140-1 can be executed on a remotely accessible computerized device via the network interface 115. In this instance, the graphical user interface 160 may be displayed locally to a user 108 of the remote computer, and execution of the processing herein may be client-server based.

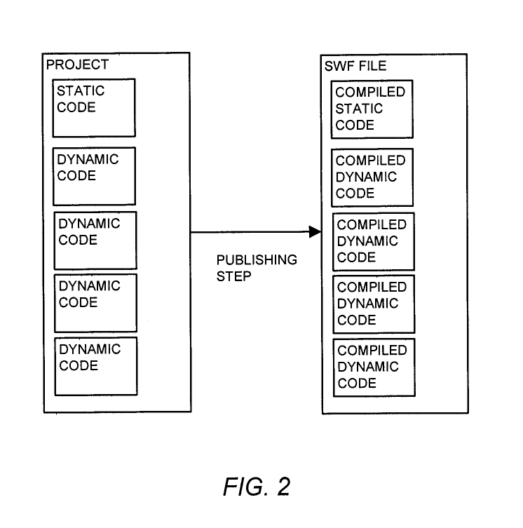

FIG. 2 is an example embodiment of current methods of compiling Action Script 3 code to create a SWF file. A project is comprised of static code and dynamic code. During the publishing step, each unique class, representing each symbol (i.e., slide object, slide element object, etc.) must be individually compiled to create compiled static code and compiled dynamic code.

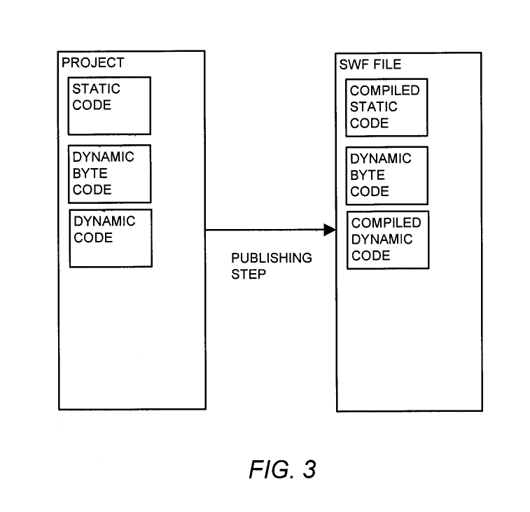

FIG. 3 is an example embodiment of the SWF compiling and executing process 140-2. The project is comprised of static code, dynamic byte code, and dynamic code. During the publishing step, the dynamic code and the static code are compiled. The SWF compiling and executing process 140-2 generates the dynamic byte code. In an example embodiment, the dynamic byte code may be compiled prior to a user invoking the publishing process.

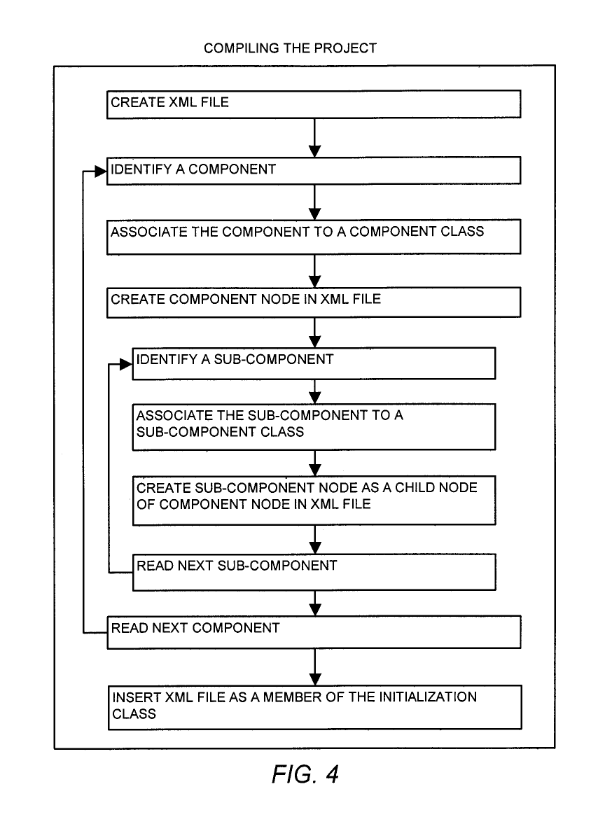

FIG. 4 is an example embodiment of the SWF compiling and executing process 140-2 when it compiles the project. The SWF compiling and executing process 140-2 traverses the project to identify components and sub-components. The SWF compiling and executing process 140-2 creates an XML file. For each component identified, the SWF compiling and executing process 140-2 associates the component to a component class, and creates a component node within the XML file. For each component identified, the SWF compiling and executing process 140-2 identifies sub-components associated with that component. The SWF compiling and executing process 140-2 associates the sub-component to a sub-component class, and creates a sub-component node in the XML file. The sub-component node is created as a child node of the component node. When the SWF compiling and executing process 140-2 has identified each component and each respective sub-component, the SWF compiling and executing process 140-2 inserts the XML file as a member of an initialization class.

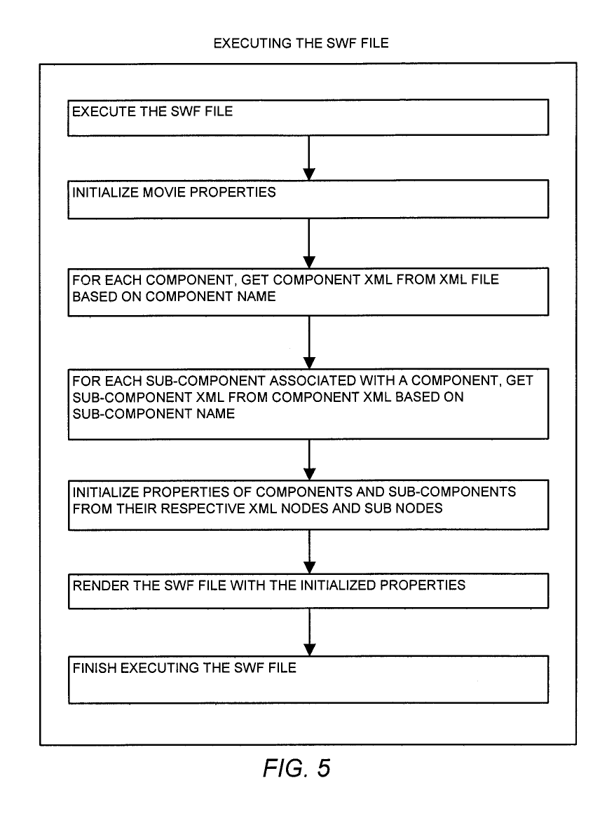

FIG. 5 is an example embodiment of the SWF compiling and executing process 140-2 when it executes the SWF file. The SWF compiling and executing process 140-2 initializes the movie properties. For each component in the SWF file, the SWF compiling and executing process 140-2 obtains the component XML, based on the component name, from the XML file. For each sub-component, associated with a component, the SWF compiling and executing process 140-2 obtains the sub-component XML, based on the sub-component name, from the XML file. The SWF compiling and executing process 140-2 initializes properties of the components and sub-components from their respective XML nodes. The SWF compiling and executing process 140-2 then finishes executing the SWF file.

Further details of configurations explained herein will now be provided with respect to a flow chart of processing steps that show the high level operations disclosed herein to perform the SWF compiling and executing process 140-2.

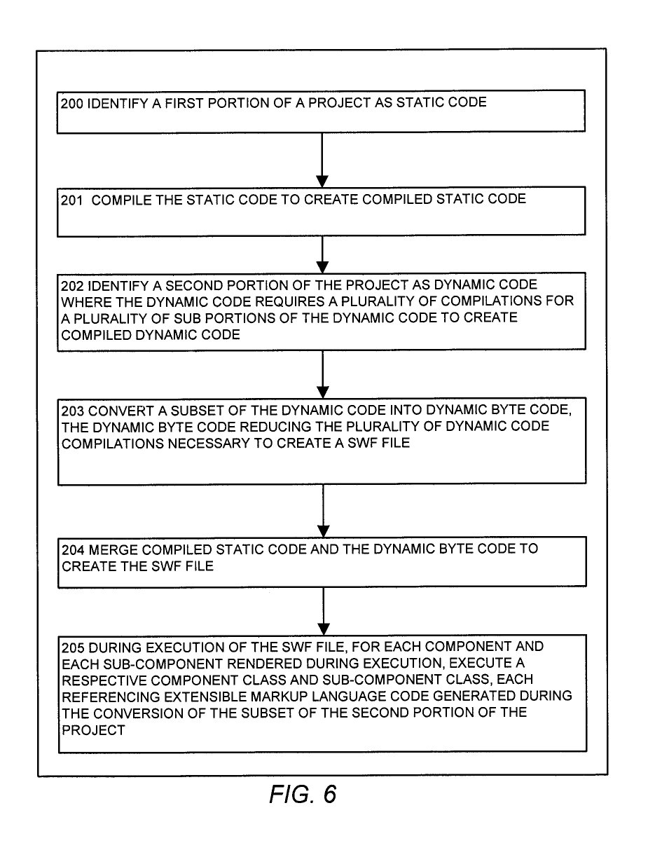

FIG. 6 is an embodiment of the steps performed by SWF compiling and executing process 140-2 when it receives notification to compile a project to create a SWF file.

In step 200, the SWF compiling and executing process 140-2 identifies a first portion of a project as static code. The SWF compiling and executing process 140-2 receives notification to compile a project (such as a Captivate project) to create a SWF file. In an example embodiment, a user 108, such as a SWF developer, brings in assets, and publishes a SWF file from Captivate in the graphical user interface 160. To compile a SWF file, the user 108 selects a ‘Publish’ option within the graphical user interface 160. The user 108 may also indicate that the SWF file uses a scripting language, such as ActionScript 3. The SWF compiling and executing process 140-2 receives notification to compile an ActionScript 3 SWF file.

In step 201, the SWF compiling and executing process 140-2 compiles the static code to create compiled static code. The SWF compiling and executing process 140-2 identifies that some of the project is static code. The static code, when compiled, is identified as compiled static code. In an example embodiment, some of the static code may be compiled before a user 108, such as an SWF developer, even selects the publishing option. In this scenario, the compiled static code may become part of a library that is available to the SWF file during execution.

In step 202, the SWF compiling and executing process 140-2 identifies a second portion of the project as dynamic code that requires a plurality of compilations for a plurality of sub portions of the dynamic code to create compiled dynamic code. In an example embodiment, for an ActionScript 3 project, each slide object and each slide element object contains initialization code that is unique to that object. Therefore, each of these objects must be compiled individually every time a user 108 publishes the SWF file. Thus, when the SWF compiling and executing process 140-2 receives notification to compile a SWF file, the SWF compiling and executing process 140-2 identifies which portions of the project are static code and which portions of the project are dynamic code. The dynamic code generally needs to be re-compiled with each iteration of publishing.

In step 203, the SWF compiling and executing process 140-2 converts a subset of the dynamic code into dynamic byte code. By converting some of the dynamic code into dynamic byte code, the plurality of dynamic code compilations necessary to create the SWF file is reduced.

In step 204, the SWF compiling and executing process 140-2 merges the compiled static code and the dynamic byte code to create the SWF file. After the SWF compiling and executing process 140-2 converts some of the dynamic code into dynamic byte code, the SWF compiling and executing process 140-2 merges the compiled static code with the dynamic byte code to create the SWF file.

During execution of the SWF file, in step 205, for each component and each sub-component rendered during execution, the SWF compiling and executing process 140-2 executes a respective component class and sub-component class. For example, a component class might be associated with a slide object and a sub-component class might be associated with a slide element object. Each component class and sub-component class references eXtensible Markup Language (XML) code generated during the conversion of the subset of the dynamic code into dynamic byte code.

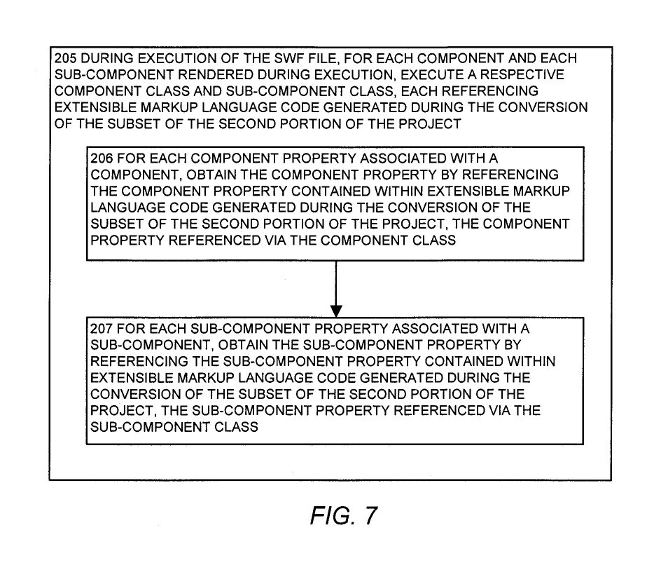

FIG. 7 is a continuation of an embodiment of FIG. 2 of the steps performed by the SWF compiling and executing process 140-2 when, for each component and each sub-component rendered during execution, the SWF compiling and executing process 140-2 executes a respective component class and sub-component class. Each component class and sub-component class references XML code generated during the conversion of the subset of the second portion of the project.

For each component property associated with a component, in step 206, the SWF compiling and executing process 140-2 obtains the component property by referencing the component property contained within XML code. The component property is referenced via the component class. The XML code is generated during the conversion of the dynamic source code. In an example embodiment, the component property is a variable, such as “m_duration”, that is associated with a movie clip. For example, within the XML code, the component property (in this example, “m_duration”) is identified as:

<movieXML>

<SlideXML name=“slide1”>

<m_duration>3</m_duration>

</SlideXML>

</movieXML>

The content of <movieXML> is XML code that is generated during the conversion process. The node <SlideXML> is a component node associated with a slide object. The component property <m_duration> identifies a variable that is associated with the slide object identified by <SlideXML>. During execution of the SWF file, the SWF compiling and executing process 140-2 references a component class associated with the slide object to obtain the initialization value for “m_duration”. An example of this component class code is as listed below:

var ACTIONSCRIPT 3Movie = true;
var slideXML:XMLList = XMLList(parent.Slide.(@name == this.name));
m_duration = slideXML.m_duration;

For each sub-component property associated with a sub-component, in step 207, the SWF compiling and executing process 140-2 obtains the sub-component property by referencing the sub-component property contained within XML code generated during the conversion of the subset of the second portion (i.e., the dynamic code) of the project. The sub-component property is referenced via the sub-component class. The XML code is generated during the conversion of the dynamic source code. In an example embodiment, the sub-component property is a variable, such as “myWidth”, that is associated with a slide element object. For example, within the XML code, the sub-component property (in this example, “myWidth”) is identified as:

var movieXML:XML = <cpMovie>

<SlideList>

<Slide name=“Slide_1”>

<ItemList>

<Item name=“Slide_Item_1”>

<myWidth>60</myWidth>
<myHeight>70</myHeight>

</Item>
<Item name=“Slide_Item_2”>

<myWidth>75</myWidth>
<myHeight>25</myHeight>

</Item>

</ItemList>
<myRotation>30</myRotation>
<myAlpha>0.75</myAlpha>

<myColor>0xff0000</myColor>

</Slide>

</movieXML>

The content of <movieXML> is XML code that is generated during the conversion process. The node <Item> is a sub-component node associated with a slide element object. The sub-component node <Item> is a child node of the component node <Slide> associated with a slide object. The sub-component property <myWidth> identifies a variable that is associated with the slide element object identified by <Item>. During execution of the SWF file, the SWF compiling and executing process 140-2 references a sub-component class associated with the slide element object to obtain the initialization value for “myWidth”. An example of this sub-component class code is as listed below:

var itemXML:XMLList = XMLList(parent.SlideXML.(@name ==
this.name));
myWidth = itemXML.myWidth;

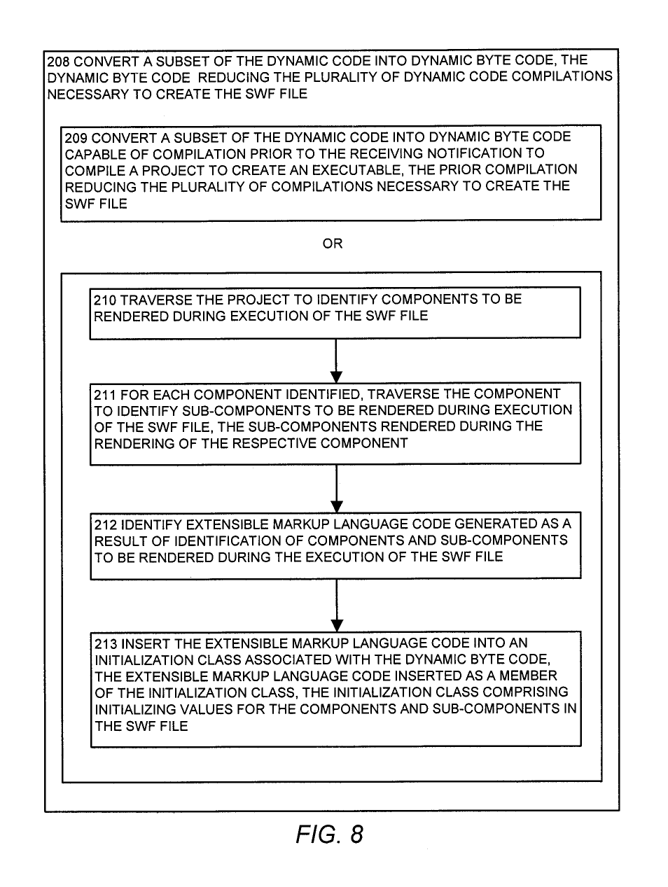

FIG. 8 is an embodiment of the steps performed by SWF compiling and executing process 140-2 when it converts a subset of the dynamic code into dynamic byte code.

In step 208, the SWF compiling and executing process 140-2 converts a subset of the dynamic code into dynamic byte code. By converting some of the dynamic code into dynamic byte code, the SWF compiling and executing process 140-2 reduces the number of compilations necessary to create the SWF file. In other words, the number of individual classes that have to be compiled each time a SWF file is published is reduced, and the SWF file compiles faster and more efficiently.

In step 209, the SWF compiling and executing process 140-2 converts a subset of the dynamic code into dynamic byte code capable of compilation prior to the receiving notification to compile a project to create a SWF file. Compiling some of the component classes and sub-component classes prior to receiving notification to publish the SWF file reduces the overall amount of time and resources necessary to publish the SWF file. In other words, the component classes and sub-component classes that represent the dynamic byte code may be compiled prior to the SWF compiling and executing process 140-2 receiving notification to publish/compile the SWF file.

Alternatively, in step 210, the SWF compiling and executing process 140-2 traverses the project to identify components to be rendered during execution of the SWF file. In an example embodiment, a user 108, such as a SWF developer, brings in assets (such as audio, images, text captions) into the project, and publishes a SWF file containing movie clips, sound effects, captions, etc. When the user 108, such as a SWF developer, publishes the SWF file, the SWF compiling and executing process 140-2 traverses the project to identify components such as movie clips. In other words, the Captivate project is parsed to identify the hierarchy and dependencies of the components and sub-components.

For each component identified, in step 211, the SWF compiling and executing process 140-2 traverses the component to identify sub-components to be rendered during execution of the SWF file. During execution of the SWF file, the sub-components are rendered during the rendering of the respective component (for example, a sound clip being played when a movie clip is played during execution of the SWF file).

In step 212, the SWF compiling and executing process 140-2 identifies XML code generated as a result of identification of components and sub-components to be rendered during the execution of the SWF file. In an example embodiment, the SWF compiling and executing process 140-2 generates the XML code as it traverses the project, and identifies each component and each sub-component associated with each component.

In step 213, the SWF compiling and executing process 140-2 inserts the XML code into an initialization class that is the dynamic byte code. The XML code is inserted as a member of the initialization class where the initialization class comprises initializing values for the components and sub-components in the SWF file. In an example embodiment, the XML code is inserted into a “CaptivateMainTimeline” class. During publishing of the SWF file, the “CaptivateMainTimeline” class is compiled.

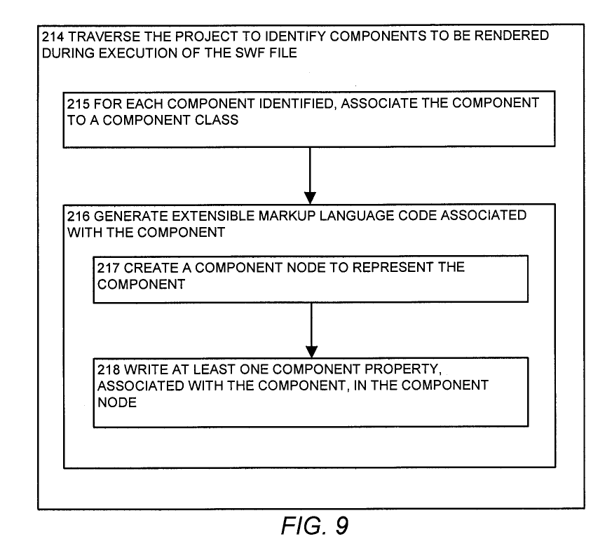

FIG. 9 is an embodiment of the steps performed by SWF compiling and executing process 140-2 when it traverses the project to identify components to be rendered during execution of the SWF file.

In step 214, the SWF compiling and executing process 140-2 traverses the project to identify components to be rendered during execution of the SWF file. The SWF compiling and executing process 140-2 traverses the project to identify components and sub-components (that are associated with respective components).

In step 215, for each component identified, the SWF compiling and executing process 140-2 associates the component to a component class. In an example embodiment, the SWF compiling and executing process 140-2 traverses the project, and identifies a component, such as a slide, and several sub-components, such as slide items. The SWF compiling and executing process 140-2 creates a slide object for the slide, and slide item objects for each slide item. The SWF compiling and executing process 140-2 generates a unique slide object identifier for the slide object, and unique slide item identifiers for each of the slide items. The SWF compiling and executing process 140-2 then adds the ActionScript 3 static code containing the class definitions for the slide class and the slide item class to the project. The SWF compiling and executing process 140-2 then associates the unique slide object identifier with the class definition for the slide class, and associates each of the unique slide item identifiers with the class definition for the slide item class. An example of this association is listed below:

<tagSymbolClass symbolCount=“3” >

<class name=“captivate.Veela_ACTIONSCRIPT 3.rdSlide”
symbolID=“7” />
<class name=“captivate.Veela_ACTIONSCRIPT 3.rdItem”
symbolID=“8” />
<class name=“captivate.Veela_ACTIONSCRIPT 3.rdItem”
symbolID=“9” />

</tagSymbolClass>

The number ‘7’ is the unique slide identifier and numbers ‘8’ and ‘9’ are the unique slide item identifiers. The unique slide identifier (i.e., ‘7’) is associated with the class definition for the slide class (i.e., ‘rSlide’). The unique slide item identifiers (i.e., ‘8’ and ‘9’) are associated with the class definition for the slide item class (i.e., ‘rdItem’).

In step 216, the SWF compiling and executing process 140-2 generates XML code associated with the component. In an example embodiment the SWF compiling and executing process 140-2 creates a blank SWF file, and then creates an empty XML file. As the SWF compiling and executing process 140-2 traverses the project (i.e., the Captivate project) to identify components, the SWF compiling and executing process 140-2 generates XML code associated with that component. Likewise, as the SWF compiling and executing process 140-2 identifies sub-components, the SWF compiling and executing process 140-2 generates XML code associated with the sub-components.

In step 217, the SWF compiling and executing process 140-2 creates a component node to represent the component. In an example embodiment, the SWF compiling and executing process 140-2 performs a loop, identifying each component (for example, a movie clip) in the SWF file. As each component is identified, the SWF compiling and executing process 140-2 creates a component object, and associates the component object with a component class. The SWF compiling and executing process 140-2 then creates a component node in the XML file. An example of the XML code is listed below. The <Slide> tag represents each slide (i.e., component) within the SWF file:

var movieXML:XML = <cpMovie>

<SlideList>

<Slide name=“Slide_1”>
</Slide>
<Slide name=“Slide_2”>
</Slide>

</SlideList>

</cpMovie>

In step 218, the SWF compiling and executing process 140-2 writes at least one component property, associated with the component, in the component node. In an example embodiment, the SWF file is written in ActionScript 3 code, and the component property is a variable within the component object. For example, the variable may be a height or width of a frame in which the component is rendered during execution of the SWF file. An example of the XML code is listed below:

<Slide name=“Slide_1”>

<myRotation>30</myRotation>
<myAlpha>0.75</myAlpha>
<myColor>0xff0000</myColor>

</Slide>

The variables ‘myRotation’, ‘myAlpha’, and ‘myColor’ represent component properties.

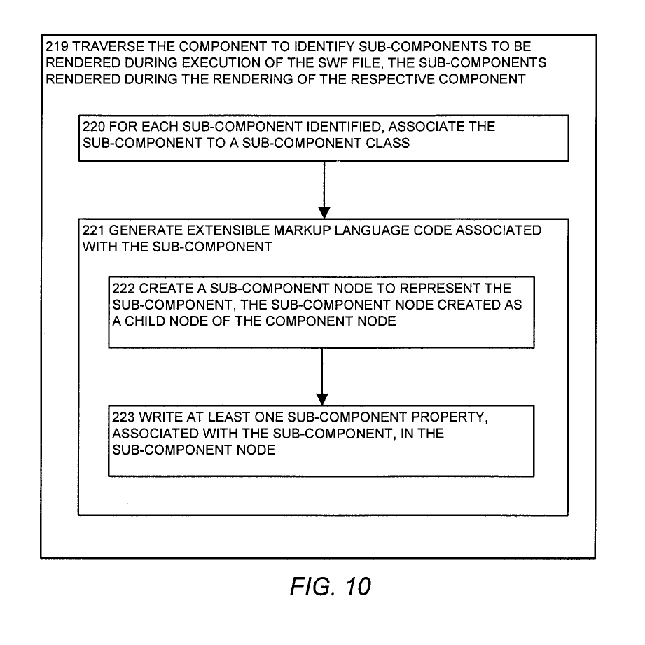

FIG. 10 is an embodiment of the steps performed by SWF compiling and executing process 140-2 when it traverses the component to identify sub-components to be rendered during execution of the SWF file.

In step 219, the SWF compiling and executing process 140-2 traverses the component to identify sub-components to be rendered during execution of the SWF file. The sub-components are rendered when the respective component is rendered during execution of the SWF file.

In step 220, for each sub-component identified, the SWF compiling and executing process 140-2 associates the sub-component to a sub-component class. In an example embodiment, the SWF compiling and executing process 140-2 traverses the project, and identifies a component, such as a slide. The SWF compiling and executing process 140-2 then traverses each slide to identify sub-components (such as slide items) associated with the identified component. The SWF compiling and executing process 140-2 creates slide item objects for each slide item. The SWF compiling and executing process 140-2 generates unique slide item identifiers for each of the slide items. The SWF compiling and executing process 140-2 adds the ActionScript 3 static code containing the class definitions for the slide item class to the project. The SWF compiling and executing process 140-2 then associates each of the unique slide item identifiers with the class definition for the slide item class. An example of this association is listed below:

<tagSymbolClass symbolCount=“3” >

<class name=“captivate.Veela_ACTIONSCRIPT 3.rdSlide”
symbolID=“7” />
<class name=“captivate.Veela_ACTIONSCRIPT 3.rdItem”
symbolID=“8” />
<class name=“captivate.Veela_ACTIONSCRIPT 3.rdItem”
symbolID=“9” />

</tagSymbolClass>

The numbers ‘8’ and ‘9’ are the unique slide item identifiers. The unique slide item identifiers (i.e., ‘8’ and ‘9’) are associated with the class definition for the slide item class (i.e., ‘rdItem’).

In step 221, the SWF compiling and executing process 140-2 generates XML code associated with the sub-component. As the SWF compiling and executing process 140-2 traverses the project identifying components and sub-components (that are associated with respective components), the SWF compiling and executing process 140-2 generates XML code for each component and sub-component identified.

In step 222, the SWF compiling and executing process 140-2 creates a sub-component node to represent the sub-component. The sub-component node is created as a child node of the component node within the XML file. An example of the XML code is listed below. The tag <Item> represents the sub-components:

<ItemList>

<Item name=“Slide_Item_1”>

<myWidth>60</myWidth>
<myHeight>70</myHeight>

</Item>
<Item name=“Slide_Item_2”>

<myWidth>75</myWidth>
<myHeight>25</myHeight>

</Item>

</ItemList>

In step 223, the SWF compiling and executing process 140-2 writes at least one sub-component property, associated with the sub-component, in the sub-component node. In an example embodiment, the Captivate project uses ActionScript 3 code, and the component property is a variable within the component object. For example, the variable may be a height or width of a frame in which the component is to be rendered during execution of the SWF file. An example of the XML code is listed below. The variables ‘myWidth’ and ‘myHeight’ represent sub-component properties:

<ItemList>
<Item name=“Slide_Item_1”>
<myWidth>60</myWidth>
<myHeight>70</myHeight>
</Item>
<Item name=“Slide_Item_2”>
<myWidth>75</myWidth>
<myHeight>25</myHeight>
</Item>
</ItemList>

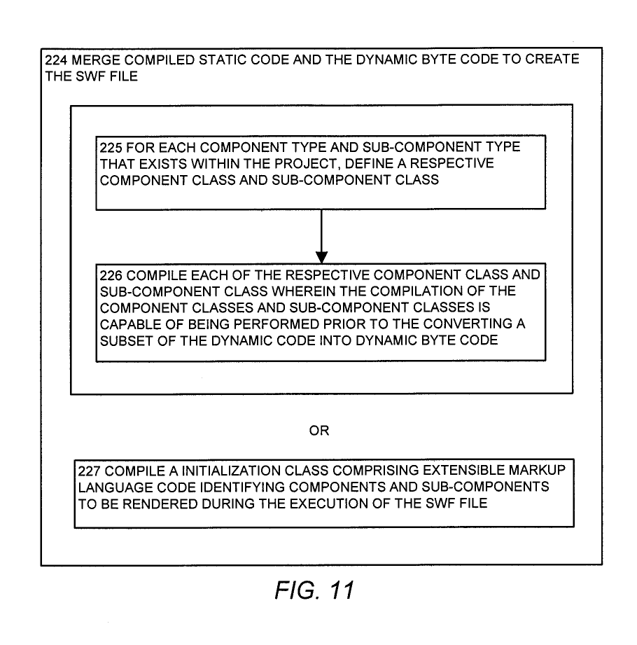

FIG. 11 is an embodiment of the steps performed by SWF compiling and executing process 140-2 when it merges the compiled static code and the dynamic byte code to create the SWF file.

In step 224, the SWF compiling and executing process 140-2 merges the compiled static code and the dynamic byte code to create the SWF file. In an example embodiment, the project uses ActionScript 3 code. The SWF compiling and executing process 140-2 creates a blank SWF file, and generates an empty XML file. For each component identified in the Captivate project, the SWF compiling and executing process 140-2 creates a component object and associates that component object with a respective component class. The SWF compiling and executing process 140-2 then generates a component node and inserts that component node into the XML file. For each component identified, the SWF compiling and executing process 140-2 identifies any sub-components associated with that component. For each sub-component identified, the SWF compiling and executing process 140-2 creates a sub-component object, and associates that sub-component object with a respective sub-component class. The SWF compiling and executing process 140-2 then generates a sub-component node, and inserts that sub-component node into the XML file as a child node of the respective component node. The component classes and sub-component classes are static code that is compiled as byte code, and pushed to the SWF file. The SWF compiling and executing process 140-2 then writes the XML file to an initialization class and compiles that initialization class. The SWF compiling and executing process 140-2 then merges the compiled static code with the compiled initialization class to create the SWF file.

In step 225, for each component type and sub-component type that exists within the project, the SWF compiling and executing process 140-2 defines a respective component class and sub-component class. These component and sub-component classes contain static code that references initialization variables (associated with the respective components and sub-components) via the XML code that is generated during the step of converting a subset of the dynamic code into static code.

In step 226, the SWF compiling and executing process 140-2 compiles each of the respective component class and sub-component class. The compilation of the component classes and sub-component classes may occur prior to the converting a subset of the dynamic code into dynamic byte code. In other words, by compiling these component and sub-component classes prior to the compilation of the SWF file, fewer classes are compiled when a user 108, such as a SWF developer, invokes the publishing action within the graphical user interface 160.

Alternatively, in step 227, the SWF compiling and executing process 140-2 compiles an initialization class. The initialization class contains the XML code (as a member of the initialization class) that identifies components and sub-components to be rendered during the execution of the SWF file. The XML code (containing initialization values for the components and sub-components) is referenced by respective component and sub-component classes during execution of the SWF file.

While computer systems and methods have been particularly shown and described above with references to configurations thereof, it will be understood by those skilled in the art that various changes in form and details may be made therein without departing from the scope disclosed herein. Accordingly, the information disclosed herein is not intended to be limited by the example configurations provided above.

1. A computer readable medium having computer readable code thereon, the medium comprising instructions for:
identifying a first portion of a project as static code;
compiling the static code to create compiled static code;
identifying a second portion of the project as dynamic code where the dynamic code requires a plurality of compilations for a plurality of sub portions of the dynamic code to create compiled dynamic code;
converting a subset of the dynamic code into dynamic byte code, the dynamic byte code reducing the plurality of dynamic code compilations necessary to create a file; and
merging the compiled static code and the dynamic byte code to create the file.

2. The computer readable medium of claim 1 comprising:
during execution of the file, for each component and each sub-component rendered during execution, executing a respective component class and sub-component class, each referencing eXtensible Markup Language code generated during the conversion of the subset of the second portion of the project.

3. The computer readable medium of claim 2 wherein executing a respective compiled component class and compiled sub-component class comprises:
for each component property associated with a component, obtaining the component property by referencing the component property contained within eXtensible Markup Language code generated during the conversion of the subset of the second portion of the project, the component property referenced via the component class; and
for each sub-component property associated with a sub-component, obtaining the subcomponent property by referencing the sub-component property contained within eXtensible Markup Language code generated during the conversion of the subset of the second portion of the project, the sub-component property referenced via the sub-component class.

4. The computer readable medium of claim 1 wherein converting a subset of the dynamic code into dynamic byte code comprises:
converting a subset of the dynamic code into dynamic byte code capable of compilation prior to the receiving notification to compile the project to create the file, the prior compilation reducing the plurality of compilations necessary to create the file.

5. The computer readable medium of claim 1 wherein converting a subset of the dynamic code into dynamic byte code comprises:
traversing the project to identify components to be rendered during execution of the file; and
for each component identified, traversing the component to identify sub-components to be rendered during execution of the file, the sub-components rendered during the rendering of the respective component.

6. The computer readable medium of claim 5 comprising:
identifying eXtensible Markup Language code generated as a result of identification of components and sub-components to be rendered during the execution of the file; and
inserting the eXtensible Markup Language code into an initialization class associated with the converted dynamic code, the eXtensible Markup Language code inserted as a member of the initialization class, the initialization class comprising initializing values for the components and sub-components in the file.

7. The computer readable medium of claim 5 wherein traversing the project to identify components to be rendered during execution of the file comprises:
for each component identified, associating the component to a component class; and
generating eXtensible Markup Language code associated with the component.

8. The computer readable medium of claim 7 wherein generating eXtensible Markup Language code associated with the component comprises:
creating a component node to represent the component; and
writing at least one component property, associated with the component, in the component node.

9. The computer readable medium of claim 5 wherein traversing the component to identify subcomponents to be rendered during execution of the file comprises:
for each sub-component identified, associating the sub-component to a sub-component class; and
generating eXtensible Markup Language code associated with the sub-component.

10. The computer readable medium of claim 9 wherein generating eXtensible Markup Language code associated with the sub-component comprises:
creating a sub-component node to represent the sub-component, the sub-component node created as a child node of the component node; and
writing at least one sub-component property, associated with the sub-component, in the sub-component node.

11. The computer readable medium of claim 1 wherein merging compiled static code and the dynamic byte code to create the file comprises:
for each component type and sub-component type that exists within the project, defining a respective component class and sub-component class; and
compiling each of the respective component class and sub-component class wherein the compilation of the component classes and sub-component classes is capable of being performed prior to the converting a subset of the dynamic code into dynamic byte code.

12. The computer readable medium of claim 1 wherein merging compiled static code and the dynamic byte code to create the file comprises:
compiling a initialization class comprising eXtensible Markup Language code identifying components and sub-components to be rendered during the execution of the file.

13. In a computer system, a method comprising:
identifying a first portion of a project as static code;
compiling the static code to create compiled static code;
identifying a second portion of the project as dynamic code where the dynamic code requires a plurality of compilations for a plurality of sub portions of the dynamic code to create compiled dynamic code;
converting a subset of the dynamic code into dynamic byte code, the dynamic byte code reducing the plurality of dynamic code compilations necessary to create a file; and
merging compiled static code and the dynamic byte code to create the file.

14. The method of claim 13 comprising:
during execution of the file, for each component and each sub-component rendered during execution, executing a respective component class and sub-component class, each referencing eXtensible Markup Language code generated during the conversion of the subset of the second portion of the project.

15. The method of claim 14 wherein executing a respective compiled component class and compiled sub-component class comprises:
for each component property associated with a component, obtaining the component property by referencing the component property contained within eXtensible Markup Language code generated during the conversion of the subset of the second portion of the project, the component property referenced via the component class; and
for each sub-component property associated with a sub-component, obtaining the subcomponent property by referencing the sub-component property contained within eXtensible Markup Language code generated during the conversion of the subset of the second portion of the project, the sub-component property referenced via the sub-component class.

16. The method of claim 13 wherein converting a subset of the dynamic code into dynamic byte code comprises:
converting a subset of the dynamic code into dynamic byte code capable of compilation prior to the receiving notification to compile the project to create the file, the prior compilation reducing the plurality of compilations necessary to create the file.

17. The method of claim 13 wherein converting a subset of the dynamic code into dynamic byte code comprises:
traversing the project to identify components to be rendered during execution of the file; and
for each component identified, traversing the component to identify sub-components to be rendered during execution of the file, the sub-components rendered during the rendering of the respective component.

18. The method of claim 13 wherein merging compiled static code and the dynamic byte code to create the file comprises:
for each component type and sub-component type that exists within the project, defining a respective component class and sub-component class; and
compiling each of the respective component class and sub-component class wherein the compilation of the component classes and sub-component classes is capable of being performed prior to the converting a subset of the dynamic code into dynamic byte code.

19. The method of claim 13 wherein merging compiled static code and the dynamic byte code to create the file comprises:
compiling a initialization class comprising eXtensible Markup Language code identifying components and sub-components to be rendered during the execution of the file.

20. A computerized device comprising:
a memory;
a processor;
a communications interface;
an interconnection mechanism coupling the memory, the processor and the communications interface;
wherein the memory is encoded with a compiling and executing application that when executed on the processor is capable of compiling and executing applications on the computerized device by performing the operations of:
identifying a first portion of a project as static code;
compiling the static code to create compiled static code;
identifying a second portion of the project as dynamic code where the dynamic code requires a plurality of compilations for a plurality of sub portions of the dynamic code to create compiled dynamic code;
converting a subset of the dynamic code into dynamic byte code, the dynamic byte code reducing the plurality of dynamic code compilations necessary to create a file; and
merging compiled static code and the dynamic byte code to create the file.

21. The computer readable medium of claim 1, wherein the dynamic byte code represents a component class and/or a component sub class of the project.
